(19) United States
(12) Patent Application Publication
(10) Pub. No.: US 2019/0066363 A1
(43) Pub. Date: Feb. 28, 2019

(54) IMAGE PROCESSING APPARATUS AND IMAGE PROCESSING METHOD

(71) Applicant: CANON KABUSHIKI KAISHA, Tokyo (JP)

(72) Inventor: Tomokazu Sato, Kawasaki-shi (JP)

(21) Appl. No.: 16/105,533

(22) Filed: Aug. 20, 2018

(30) Foreign Application Priority Data
Aug. 22, 2017 (JP) 2017-159144

(51) Int. Cl. G06T 15/20; G06T 15/04; G06T 7/80

(52) U.S. Cl. CPC G06T 15/205; G06T 15/04; G06T 2207/10004; G06T 2215/16; G06T 2200/08; G06T 7/80

(57) ABSTRACT

An image processing apparatus includes a selection unit configured to select a camera viewpoint corresponding to each of polygons of a 3D polygon model representing a shape of a subject from among a plurality of camera viewpoints in which images of the subject are captured, and an allocation unit configured to determine texture to be allocated to each of the polygons of the 3D polygon model based on image data captured in the camera viewpoint selected by the selection unit, wherein the selection unit selects a camera viewpoint corresponding to each of polygons based on (1) a resolution of the polygon from the camera viewpoint, and (2) an angle formed by a front direction of the polygon and a direction toward the camera viewpoint from the polygon.

### BACKGROUND OF THE INVENTION

### Field of the Invention

The present invention relates to an image processing apparatus and an image processing method.

### Description of the Related Art

Japanese Patent Application Laid-Open No. 2003-337953 discusses an image processing apparatus that generates a three-dimensional (3D) image by attaching a texture image to a 3D shape model. The image processing apparatus selects a texture image on a patch surface basis based on an image quality evaluation value to which data about a distance between a patch surface and each viewpoint and direction data with respect to a patch surface of each viewpoint are applied. Then, the image processing apparatus executes matching processing with endpoint movement based on data about error in pixel values between texture images in a patch boundary portion, and assigns a large weight to a pixel value of a texture image in a viewpoint direction facing the patch surface among adjacent texture images. Then, the image processing apparatus calculates a pixel value in the patch boundary portion. Moreover, the image processing apparatus calculates a pixel value within the patch surface based on the pixel value in the patch boundary by applying a weight coefficient inversely proportional to a distance from the patch boundary.

If there is a difference between a 3D model shape and a subject shape, texture may be distorted due to such a difference. That is, in Japanese Patent Application Laid-Open No. 2003-337953, if there is a camera viewpoint in high resolution is captured from a direction oblique to a projection plane, such a camera viewpoint is selected with priority. In this case, if a shape of a 3D model and a real subject shape have a large error, projected texture may be distorted due to shape displacement.

### SUMMARY OF THE INVENTION

According to an aspect of the present disclosure, an image processing apparatus includes a selection unit configured to select a camera viewpoint corresponding to each of polygons of a 3D polygon model representing a shape of a subject from among a plurality of camera viewpoints in which images of the subject are captured, and an allocation unit configured to determine texture to be allocated to each of the polygons of the 3D polygon model based on image data captured in the camera viewpoint selected by the selection unit, wherein the selection unit selects a camera viewpoint corresponding to each of polygons based on (1) a resolution of the polygon from the camera viewpoint, and (2) an angle formed by a front direction of the polygon and a direction toward the camera viewpoint from the polygon.

Further features of the present disclosure will become apparent from the following description of exemplary embodiments with reference to the attached drawings.

### BRIEF DESCRIPTION OF THE DRAWINGS

FIGS. 1A, 1B, and 1C are diagrams illustrating an overview relating to rendering a three-dimensional (3D) polygon with texture.

FIGS. 2A, 2B, and 2C are diagrams illustrating correspondence between a 3D polygon and texture.

FIGS. 3A, 3B, 3C, and 3D are diagrams illustrating data for expression of the 3D polygon with texture.

FIGS. 4A and 4B are diagrams illustrating a set of triangles in the same front direction.

FIG. 5 is a diagram illustrating multiple cameras.

FIG. 6 is a block diagram illustrating a configuration example of an image processing apparatus.

FIG. 7 is a flowchart illustrating a processing method performed by the image processing apparatus.

FIG. 8 is a block diagram illustrating a configuration example of a texture mapping unit.

FIGS. 9A and 9B are flowcharts illustrating processing performed by the texture mapping unit.

FIG. 10 is a diagram illustrating a parameter for an evaluation value.

FIG. 11A and 11B are diagrams illustrating displacement of texture mapping.

FIG. 12 is a diagram illustrating an example of a weight.

FIG. 13 is a diagram illustrating a 3D polygon model including an uneven surface that is not present in practice.

FIG. 14 is a diagram illustrating a hardware configuration example of the image processing apparatus.

### DESCRIPTION OF THE EMBODIMENTS

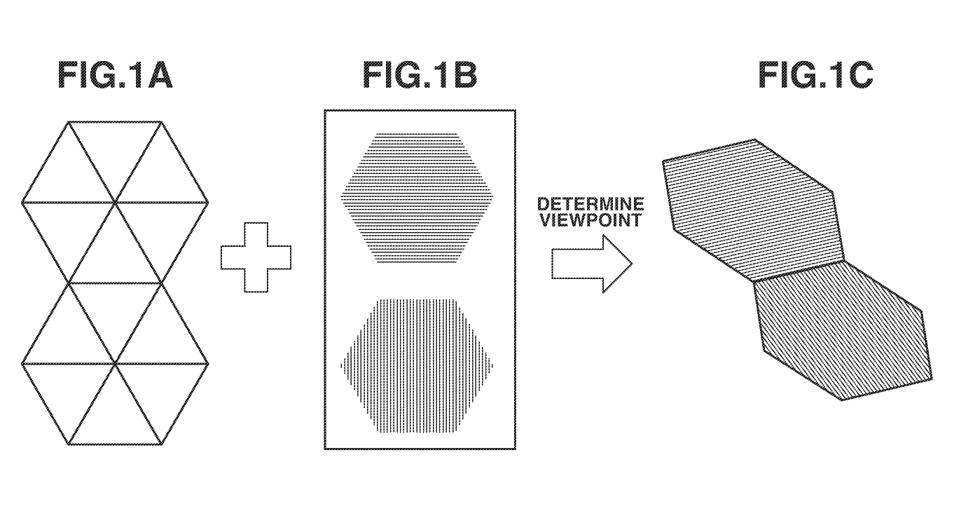

FIGS. 1A through 1C are diagrams illustrating processing that is performed by an image processing apparatus according to a first exemplary embodiment and a method for generating a three-dimensional (3D) polygon model with texture. The 3D polygon model includes polygons, for example, triangle polygons. Hereinafter, a 3D polygon model will be described in which texture is added to a triangle polygon. The polygon is not limited to triangle. FIG. 1A illustrates a 3D polygon model and a shape of a triangle polygon model, for example. FIG. 1B illustrates texture. FIG. 1C illustrates a 3D polygon model with texture. The image processing apparatus determines a combination of the 3D polygon model in FIG. 1A and the texture in FIG. 1B. Then, through 3D rendering processing, the image processing apparatus generates an image of a 3D polygon model with texture from an input viewpoint (an optional viewpoint) as illustrated in FIG. 1C.

The image processing apparatus can generate a 3D polygon model with texture based on a captured real image, render a subject from a free virtual viewpoint without constraints on arrangement of a camera viewpoint, and observe the subject. The image processing apparatus projects an image captured by a camera onto a 3D polygon model of a subject, and generates a texture image and a UV map for correspondence between vertexes of the 3D polygon model and coordinates on the texture images. Then, the image processing apparatus performs rendering to generate an image (a virtual viewpoint image) of a 3D polygon model with texture in a desired virtual viewpoint.

Texture mapping techniques are classified into a method for generating texture before determination of a virtual viewpoint (hereinafter referred to as a method “1”), and a method for generating texture after determination of a virtual viewpoint (hereinafter referred to as a method “2”), depending on texture generation timing. The method “1” can perform optimum mapping with respect to a virtual viewpoint. In the method “2”, since processing to be performed after determination of a viewpoint is only rendering, an interactive viewpoint operation is readily provided to a user. The image processing apparatus according to the present exemplary embodiment generates texture according to the method “2”.

Methods for generating a UV map are classified into a method for generating a UV map first (hereinafter referred to as a method “A”), and a method for generating a texture image first (hereinafter referred to as a method “B”), depending on whether a UV map or a texture image is generated first. In the method “A”, images captured by a plurality of cameras are projected onto a texture image according to a UV map to generate texture. In the method “B”, an optimum camera viewpoint is selected for each polygon, an image captured in such a camera viewpoint is arranged on a texture image, and then a UV map is calculated such that the arrangement is referred. According to the method “A”, since color information projected from a plurality of viewpoints is blended to determine a pixel value of the texture image, color misregistration due to individual differences of cameras is more easily compensated. According to the method “A”, however, if accuracy of a shape of a 3D model or a camera parameter is poor, colors that are originally positioned in a different position of a subject is mistakenly blended. This causes texture to be more easily degraded. On the other hand, the method “B” generates texture without blending colors of a plurality of viewpoints, so that sharpness tends to be maintained. Moreover, the method “B” is robust for positional displacement. The image processing apparatus according to the present exemplary embodiment generates a UV map by using the method “B”.

The image processing apparatus according to the present exemplary embodiment is directed to provide a user interactive free viewpoint image based on a 3D model with shape accuracy that is not high. Accordingly, the image processing apparatus according to the present exemplary embodiment generates an image of a 3D polygon model with texture by a combination of the above-described texture generation method (the method “2”) and the above-described UV map generation method (the method “B”).

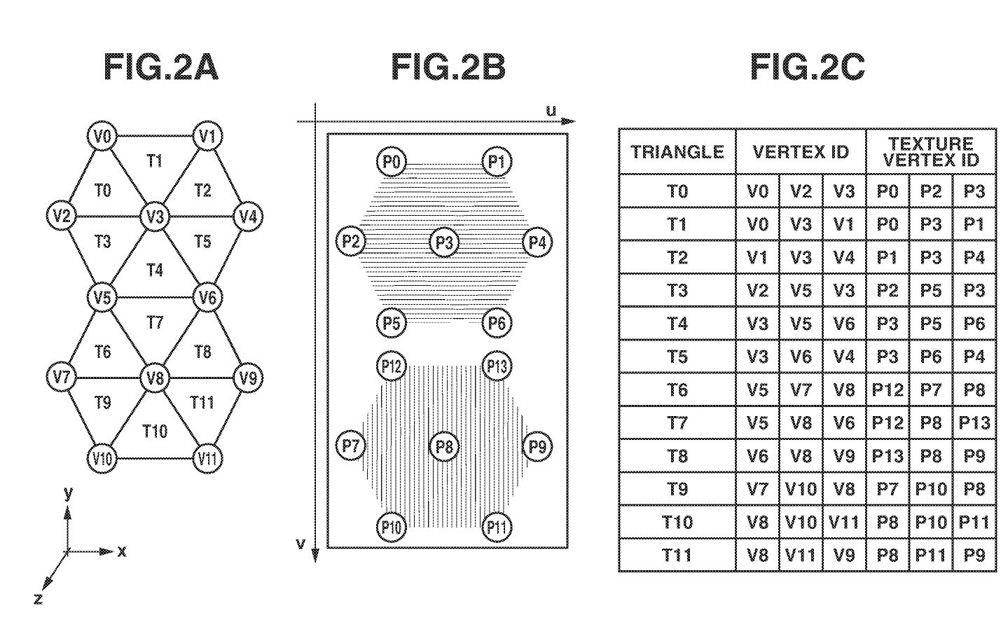

FIGS. 2A through 2C are diagrams illustrating correspondence between the 3D polygon model in FIG. 1A and the texture in FIG. 1B. FIG. 2A illustrates triangles T0 through T11 and vertexes V0 through V11 forming the triangles T0 through T11 as elements for expressing a shape of the 3D polygon in FIG. 1A. FIG. 2B illustrates positions P0 through P13 that correspond to the vertexes V0 through V11 of the shape in FIG. 2A on the texture image in FIG. 1B. FIG. 2C illustrates a correspondence table of vertex identifications (IDs) in a 3D space including the triangles T0 through T11 and texture vertex IDs in a texture image space with respect to each of the triangles T0 through T11. The table in FIG. 2C is information to be used for correspondence between FIGS. 2A and 2B. The image processing apparatus can attach the texture in FIG. 1B to the shape in FIG. 1A based on the table in FIG. 2C. The coordinates in FIG. 2A are expressed by coordinates in a 3D space with x, y, and z axes, whereas the coordinates in FIG. 2B are expressed by coordinates in a two-dimensional (2D) image space with u and v axes. In most cases, a vertex and a texture vertex have one-to-one correspondence as to the vertexes V0 through V4 and V7 through V11 in FIG. 2C. Thus, index numbers are matched, so that the vertex and the texture vertex can be expressed. However, as similar to the vertex V5 that corresponds to texture vertexes P5 and P12, there is a vertex that corresponds to different positions in the image space although one vertex is provided in the 3D space. Thus, the vertex ID and the texture vertex ID are independently managed such that such a texture correspondence relation can be processed.

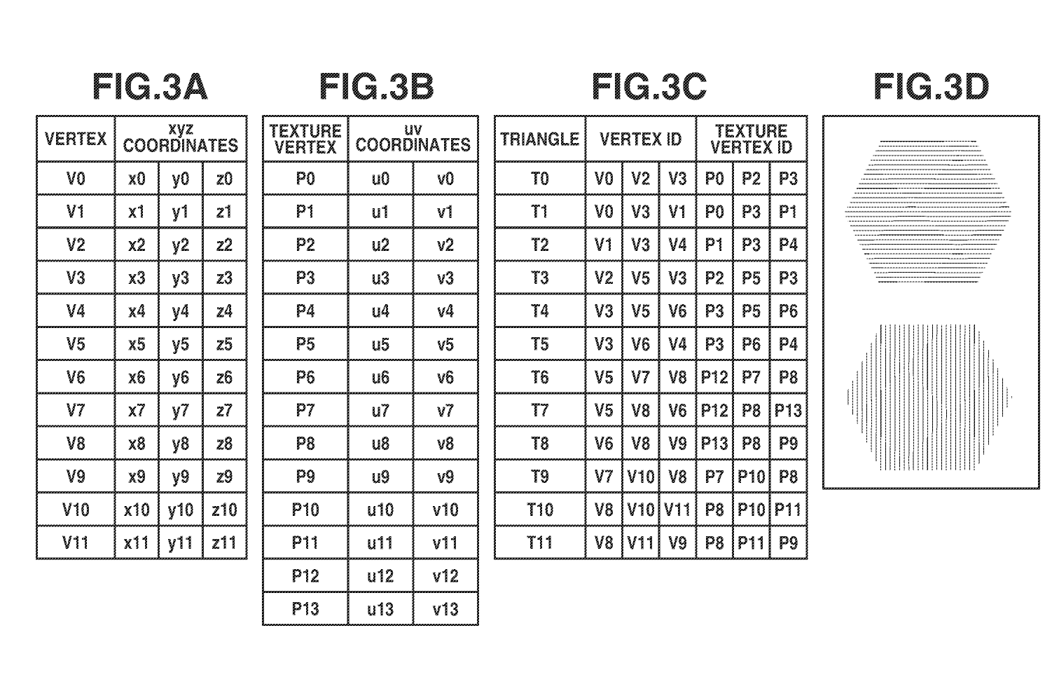

FIG. 3A is a diagram illustrating data to be used to express the 3D polygon with texture. FIG. 3A illustrates data of a vertex coordinate list corresponding to FIG. 2A. FIG. 3B illustrates data of a texture vertex coordinate list corresponding to FIG. 2B. FIG. 3C illustrates data of a correspondence table of the triangle, the vertex, and the texture vertex. The data in FIG. 3C corresponds to that in FIG. 2C. FIG. 3D illustrates a texture image corresponding to FIG. 1B.

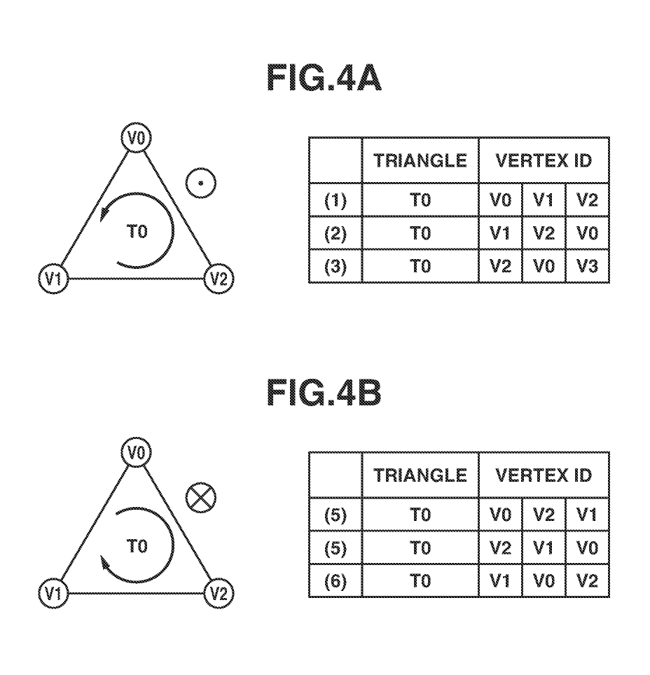

Arrangement of the vertex IDs has a function of defining a front-side direction of a plane. The triangle T0 has three vertexes, and there are six arrangements of order of the three vertexes. A direction that conforms to the right-handed screw rule with respect to a rotation direction in a case where the vertexes are followed in order from the left side is often defined as a front-side direction. Each of FIGS. 4A and 4B illustrates a set of describing order of vertexes and a front-side direction of a triangle. In FIG. 4A, a direction from the back toward the front with respect to a sheet surface is the front of the triangle. In FIG. 4B, a direction from the front toward the back with respect to the sheet surface is the front of the triangle.

The data expression of the texture and the 3D polygon has been described. However, the present exemplary embodiment is not limited to the above-described data expression. For example, the present exemplary embodiment can be applied to expression of a polygon such as a rectangle or polygonal shape which has more corners. Moreover, the present exemplary embodiment can be applied to various cases including a case where coordinates are directly described for expression of a correspondence relation between shape and texture without using an index, and a case where the definition of the front-side direction of the triangle is reversed.

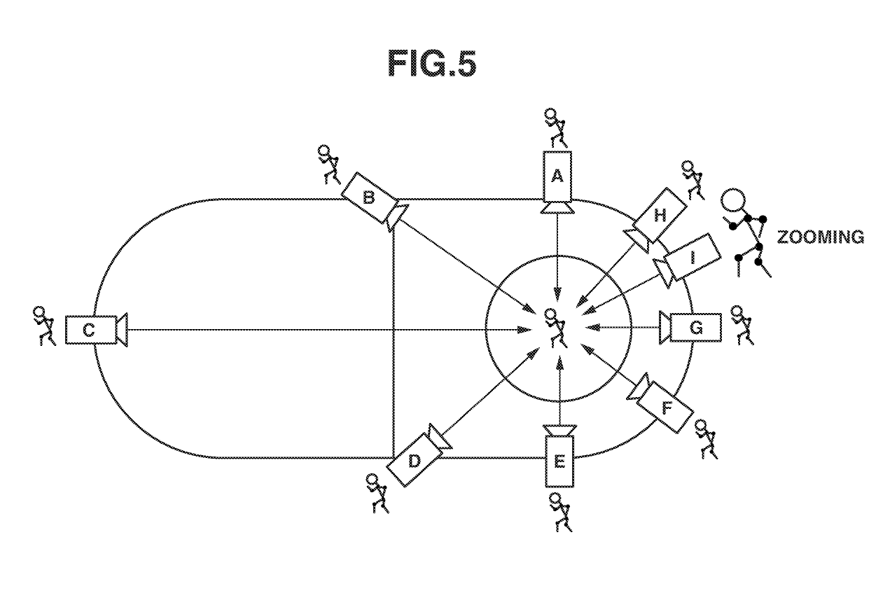

FIG. 5 illustrates multiple cameras. The image processing apparatus according to the present exemplary embodiment performs texture mapping (attachment of texture) with respect to a 3D polygon based on images acquired by multiple cameras A though H in FIG. 5. In the multiple cameras in FIG. 5, viewpoints of the cameras A through H are arranged such that angles formed by the adjacent cameras with respect to a fixation point positioned in the center of a circle are substantially equal. Each of the cameras A through H is set such that an image of a subject is captured at similar resolution in the fixation point. A viewpoint of a camera I is set such that an image of the subject is captured at higher resolution than the other cameras A through H. The image processing apparatus according to the present exemplary embodiment performs suitable texture mapping in the multiple cameras having a complex configuration in which a distance between a subject and each of the cameras A through I differs and the cameras A through I have different settings.

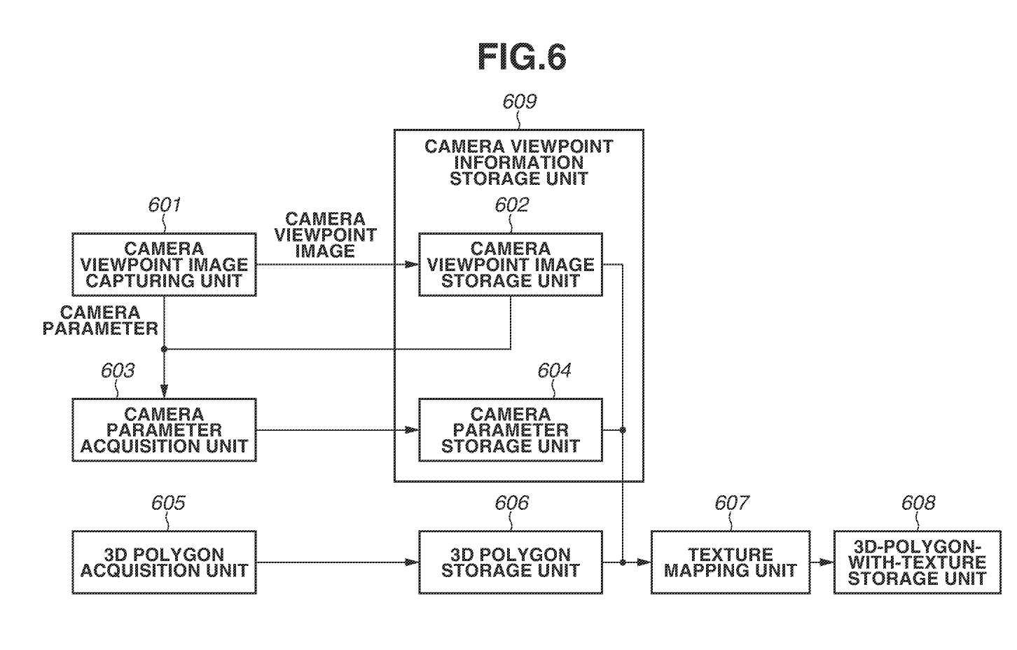

FIG. 6 is a block diagram illustrating a configuration example of the image processing apparatus. The image processing apparatus includes a camera viewpoint image capturing unit 601, a camera parameter acquisition unit 603, and a camera viewpoint information storage unit 609. Moreover, the image processing apparatus includes a 3D polygon acquisition unit 605, a 3D polygon storage unit 606, a texture mapping unit 607, and a 3D-polygon-with-texture storage unit 608. The camera viewpoint information storage unit 609 includes a camera viewpoint image storage unit 602 and a camera parameter storage unit 604.

The camera viewpoint image capturing unit 601 includes the cameras A through I in FIG. 5. The camera viewpoint image capturing unit 601 captures images while synchronizing with each of the cameras A through I, and stores the captured images in the camera viewpoint image storage unit 602. The camera viewpoint image capturing unit 601 stores a calibration image in which a calibration marker is imaged, a background image in which a subject is not present, and a captured image including a subject for texture mapping in the camera viewpoint image storage unit 602. The camera parameter acquisition unit 603 considers a camera parameter supplied from the camera viewpoint image capturing unit 601 as an initial value, and uses the calibration image stored in the camera viewpoint image storage unit 602 to acquire a camera parameter. Then, the camera parameter acquisition unit 603 stores the acquired camera parameter in the camera parameter storage unit 604.

The 3D polygon acquisition unit 605 acquires a 3D polygon model representing a subject shape in the 3D space, and stores the 3D polygon model in the 3D polygon storage unit 606. The 3D polygon acquisition unit 605 applies a visual hull algorism to acquire voxel information, and reconstructs the 3D polygon model. An example of the 3D polygon model acquisition method may include an optional method. For example, voxel information can be directly converted into a 3D polygon model. Moreover, an example of the 3D polygon model acquisition method can include application of poisson surface reconstruction (PSR) to a point group acquired from a depth map that is acquired using an infrared sensor. An example of a point group acquisition method can include stereo matching that uses image features and is typified by patch-based multi-view stereo (PMVS). The texture mapping unit 607 reads out the captured image in which the subject appears, the camera parameter, and the 3D polygon model from the respective storage units 602, 604, and 606, and performs texture mapping on the 3D polygon to generate a 3D polygon with texture. Then, the texture mapping unit 607 stores the generated 3D polygon with texture in the 3D-polygon-with-texture storage unit 608.

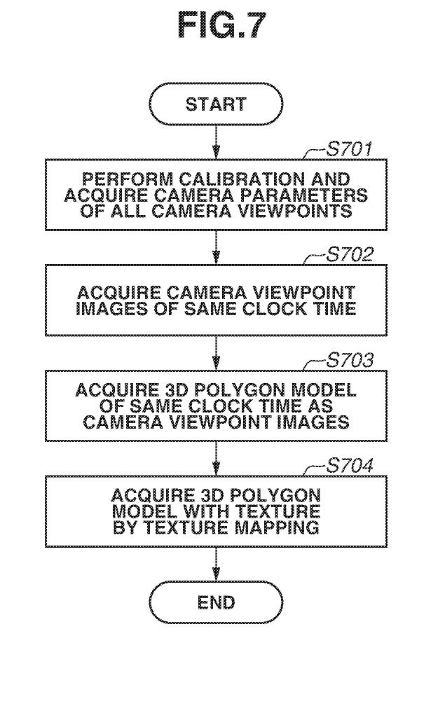

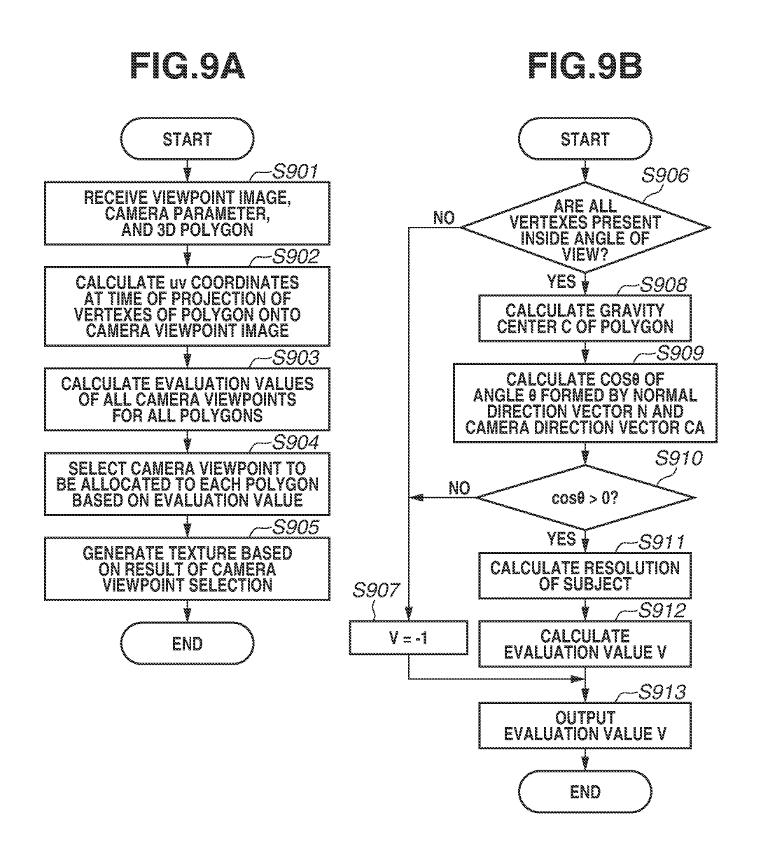

FIG. 7 is a flowchart illustrating an image processing method performed by the image processing apparatus in FIG. 6. A central processing unit (CPU) 1401 (described below) of the image processing apparatus reads out a predetermined program from a read only memory (ROM) 1403, and executes the processing in FIG. 7. However, all of or one portion of the processing in FIG. 7 may be executed by a hardware processor different from the CPU 1401. The hardware processor different from the CPU 1401 is, for example, an application specific integrated circuit (ASIC), a field programmable gate array (FPGA), and a digital signal processor (DSP). Similarly, flowcharts in FIGS. 9A and 9B can be performed. In step S701, the camera parameter acquisition unit 603 uses a calibration image stored in the camera viewpoint image storage unit 602 to perform calibration (e.g., acquisition of the camera parameter of each of the cameras A through I), and then acquires camera parameters of all of the cameras A through I. The camera parameters include an external parameter and an internal parameter. The external parameter includes a position and/or orientation of a camera, whereas the internal parameter includes a focal length and/or optical center. The focal length as the internal parameter is not a distance between a lens center and a camera sensor surface in a pinhole model in the general optical field. The focal length as the internal parameter is expressed by dividing a distance between a lens center and a camera sensor surface by a pixel pitch (a sensor size per pixel). The camera parameter acquisition unit 603 stores the acquired camera parameters in the camera parameter storage unit 604.

Next, in step S702, the camera viewpoint image capturing unit 601 acquires images captured at the same clock time by the cameras A through I, and stores the acquired captured-images in the camera viewpoint image storage unit 602. Subsequently, in step S703, the 3D polygon acquisition unit 605 acquires a 3D polygon model of the same clock time as the captured images acquired in step S702, and stores the acquired 3D polygon model in the 3D polygon storage unit 606. In step S704, the texture mapping unit 607 attaches texture (the captured image) to the 3D polygon model by performing texture mapping to acquire a 3D polygon model with texture. The texture mapping unit 607 stores the 3D polygon model with texture in the 3D-polygon-with-texture storage unit 608. Image data to be attached to the texture may be generated by blending a plurality of captured images.

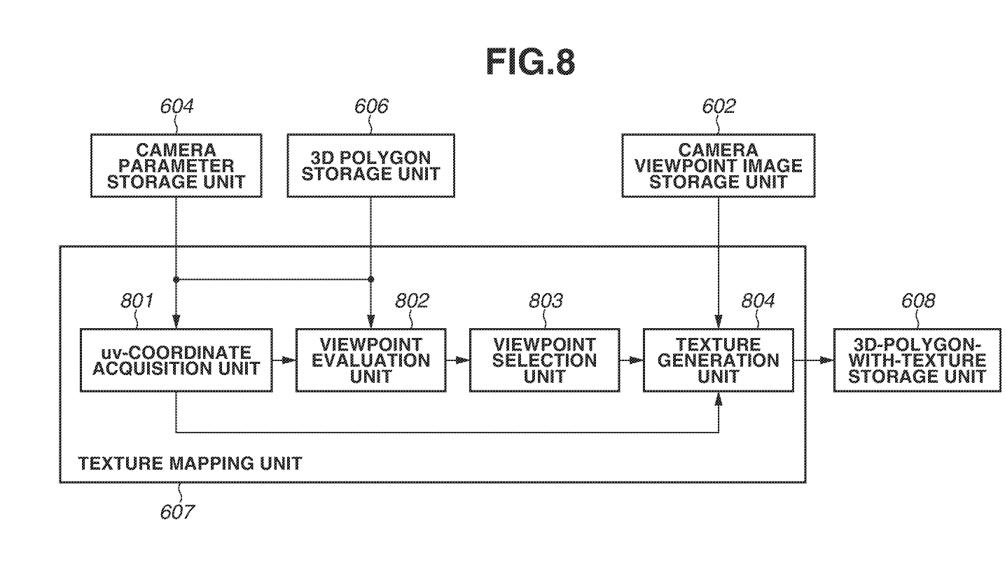

FIG. 8 is a block diagram illustrating a configuration example of the texture mapping unit 607 in FIG. 6. The texture mapping unit 607 includes a uv-coordinate acquisition unit 801, a viewpoint evaluation unit 802, a viewpoint selection unit 803, and a texture generation unit 804. The uv-coordinate acquisition unit 801 uses the camera parameter read from the camera parameter acquisition unit 603 to acquire uv coordinates for each of vertexes of the 3D polygon stored in the 3D polygon storage unit 606. In particular, the uv coordinates at the time of projection of each of such vertexes onto each captured image are acquired. The viewpoint evaluation unit 802 calculates an evaluation value of each of all camera viewpoints for each triangle of the 3D polygon. The evaluation value serves as a reference for selection of a camera viewpoint to be an origin for attachment of texture to the triangle. The viewpoint selection unit 803 selects a camera viewpoint having the largest evaluation value from among the evaluations values of all the camera viewpoints with respect to each triangle. The viewpoint selection unit 803 selects one camera viewpoint on a triangle (on a polygon) from among a plurality of viewpoints in which images of the same subject are captured, in a case where texture is allocated to each triangle (polygon) of the 3D polygon model. The texture generation unit 804 integrates, into one texture image, one portions of the images captured in the camera viewpoints selected for respective triangles, and calculates uv coordinates on the texture image such that the triangle can refer to a necessary position on the texture. Then, the texture generation unit 804 as an allocation unit allocates, as texture to each triangle, the image captured in the camera viewpoint selected on a triangle, and stores the image in a format as in FIGS. 3A through 3D in the 3D-polygon-with-texture storage unit 608.

FIG. 9A is flowchart illustrating processing performed by the texture mapping unit 607. In step S901, the texture mapping unit 607 receives a captured image, a camera parameter, and a 3D polygon model from the respective storage units 602, 604, and 606. Subsequently, in step S902, the uv-coordinate acquisition unit 801 calculates uv coordinates at the time of projection of all of vertexes of the 3D polygon onto the images captured by all of the cameras. The coordinates are calculated for all the vertexes of the 3D polygon. Here, a subject may be outside an angle of view of a captured image. In such a case, error values (e.g., negative values) are set to uv coordinates, so that such coordinates can be used as a flag indicating that the captured image is not usable in subsequent processing.

In step S903, the viewpoint evaluation unit 802 calculates evaluation values of all the camera viewpoints for all polygons. A method for calculating the evaluation value will be described in detail below. Subsequently, in step S904, the viewpoint selection unit 803 selects a camera viewpoint for allocation of texture to each polygon based on the evaluation value. The viewpoint selection unit 803 selects a camera viewpoint having a largest evaluation value. In step S905, the texture generation unit 804, based on an image captured in the selected camera viewpoint, generates a texture image and uv coordinates on the texture image and allocates the texture image to each polygon.

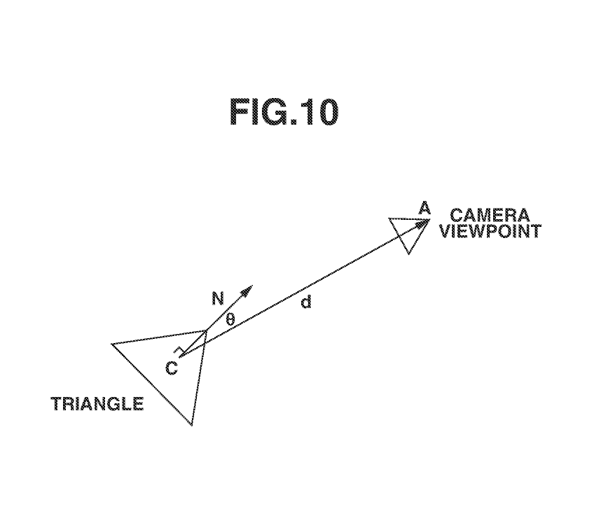

Next, processing for calculating the aforementioned evaluation value will be described with reference to FIGS. 9B and 10. FIG. 9B is a flowchart illustrating processing for calculating an evaluation value with respect to a triangle of a camera viewpoint when one triangle and one camera viewpoint are provided. FIG. 10 is a schematic diagram of each parameter.

In step S906, the viewpoint evaluation unit 802 determines whether all vertexes forming a triangle are present inside an angle of view of the image captured by the camera. If all of the uv coordinates calculated in step S902 are positive, the viewpoint evaluation unit 802 can determine that all the vertexes are present inside the angle of view. If the viewpoint evaluation unit 802 determines that all the vertexes are present inside the angle of view (YES in step S906), the processing proceeds to step S908. If the viewpoint evaluation unit 802 determines that the vertexes are not present inside the angle of view (NO in step S906), the processing proceeds to step S907. In step S907, the viewpoint evaluation unit 802 sets an evaluation value V to −1, and the processing proceeds to step S913.

In step S908, the viewpoint evaluation unit 802 calculates a gravity center C of three vertexes as a representative point of the triangle as in FIG. 10. Subsequently, in step S909, the viewpoint evaluation unit 802 calculates an inner product of a front direction vector N of the triangle and a camera direction vector CA as in FIG. 10, thereby acquiring a cosine θ of an angle θ formed by the front direction vector N of the triangle and the camera direction vector CA. The front direction of the triangle is perpendicular to the triangle, and represents not only a front direction defined by vertex order but also a normal direction of the triangle. The camera direction represents a direction toward a camera viewpoint (a camera position) A acquired by an external parameter from the gravity center C of the triangle.

Subsequently, in step S910, the viewpoint evaluation unit 802 determines whether the cosine θ is greater than zero. If the viewpoint evaluation unit 802 determines that the cosine θ is not greater than zero (NO in step S910), it is determined that a surface of the triangle does not appear in an image captured by the camera, and thus the image captured in this camera viewpoint is not to be used. Consequently, the processing proceeds to step S907. If the viewpoint evaluation unit 802 determines that the cosine θ is greater than zero (YES in step S910), the processing proceeds to step S911.

In step S911, the viewpoint evaluation unit 802 calculates a resolution S of the triangle from the camera viewpoint. In step S912, the viewpoint evaluation unit 802 calculates an evaluation value V of this camera viewpoint based on the resolution S of the triangle. The calculation method will be described below. Subsequently, in step S913, the viewpoint evaluation unit 802 outputs the evaluation value V.

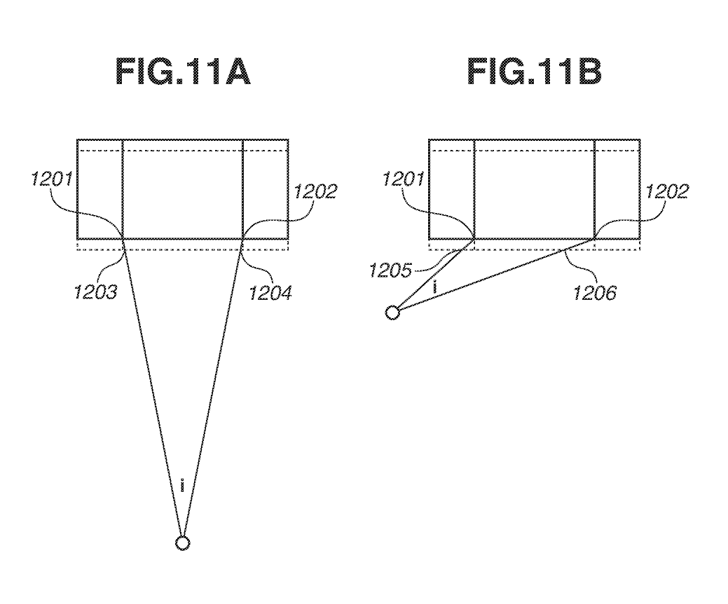

Next, the method for calculating an evaluation value V in step S912 will be described in detail. The viewpoint evaluation unit 802 calculates a resolution S of a triangle, and the viewpoint selection unit 803 preferentially selects a camera viewpoint providing a high resolution S of a triangle. The resolution S of the triangle corresponds to, for example, an area size (the number of pixels) of a triangle projected onto an image captured by a camera. However, there may be an error in shape. In such a case, a high gradient of the camera viewpoint with respect to a subject plane causes texture to be distorted. Hereinafter, displacement of texture mapping due to an angle of camera viewpoint will be described with reference to FIGS. 11A and 11B.

Each of FIGS. 11A and 11B illustrates a case where the same subject is projected in a same area size from a different camera position. A solid-line rectangle represents an actual shape of a subject, whereas a broken-line rectangle represents a shape of a subject based on estimation and includes an error. Herein, FIG. 11A illustrates a shape captured from a front camera viewpoint with respect to a subject plane. FIG. 11B illustrates a shape captured from a camera viewpoint oblique to the subject plane. A point 1201 of the subject is projected in a point 1203 in FIG. 11A and a point 1205 in FIG. 11B. A point 1202 of the subject is projected in a point 1204 in FIG. 11A and a point 1206 in FIG. 11B. The oblique camera viewpoint in FIG. 11B causes generation of large distortion in texture mapping with respect to the front camera viewpoint in FIG. 11A.

Accordingly, the viewpoint evaluation unit 802 provides a weight of W=1 if the angle θ is a threshold (an angle at which it is possible to withstand a shape error) or less. The viewpoint evaluation unit 802 provides a weight of W=0 if the angle θ is not the threshold or less, thereby setting an evaluation value to zero. Accordingly, the viewpoint selection unit 803 can exclude a camera viewpoint that is likely to cause large distortion mapping, and then can select texture having high resolution. Based on Expression 1, the viewpoint evaluation unit 802 calculates a product of the triangle resolution S and the weight W as an evaluation value V.

V=SW (1)

The viewpoint selection unit 803 selects a camera viewpoint providing the highest triangle resolution S from among camera viewpoints each having an angle θ of the threshold value or less. The triangle resolution S may be a value acquired by calculation of a size of a subject per pixel based on a focal length of the camera and a distance between the camera and the triangle in addition to an area size of the triangle projected onto the image captured by the camera. Alternatively, the triangle resolution S may be determined based on a lookup table.

Therefore, in a case where a camera viewpoint for providing texture with respect to a polygon is selected, even if a shape of a 3D polygon may have an error with respect to an actual shape, distortion of texture mapping can be reduced. The texture mapping unit 607 considers a resolution of a camera that captures an image from a direction oblique to a subject plane as zero to exclude a viewpoint of such a camera, and selects a camera viewpoint for providing texture to a polygon. Thus, distortion of texture mapping can be reduced even with respect to a 3D polygon model having a shape error.

A second exemplary embodiment will be described. In the first exemplary embodiment, an angle at which mapping can withstand a shape error is set as a threshold, and a weight W is set to zero if the angle θ is not the threshold or less, so that mapping distortion is reduced. However, in the method for excluding a camera viewpoint by using such an angle threshold, a camera viewpoint cannot be selected if all of camera viewpoints are excluded. Moreover, the use of the angle threshold may cause a negative effect, e.g., a camera viewpoint in which an image can be captured with high resolution is excluded due to an angle θ that is slightly larger than the threshold even though the angle is almost as equal as the threshold.

In the second exemplary embodiment, a case will be described where a weight corresponding to an angle θ is changed as continuously as possible such that an abrupt change in camera viewpoint selection is prevented. An image processing apparatus of the second exemplary embodiment is similar to that of the first exemplary embodiment in terms of configurations and processing, except for a method for calculating an evaluation value V by a viewpoint evaluation unit 802 and definition of a front direction which will be described below. Hereinafter, the points, which differ from those of the first exemplary embodiment, will be described.

The viewpoint evaluation unit 802 calculates an evaluation value V based on a resolution S of a triangle and a weight cosine θ as illustrated in Expression 2, where the cosine θ is a weight with respective to an angle θ.

V=S cos θ (2)

As for the weight, any weighting function other than cosine θ can be used as long as the weight is maximum when the angle θ is 0° and the angle θ monotonically decreases in a range of zero to 90°. The evaluation value V is used for exclusion of a camera viewpoint having an excessively large angle θ to prevent distortion of texture mapping due to a shape error although a camera viewpoint providing a possibly highest resolution is employed.

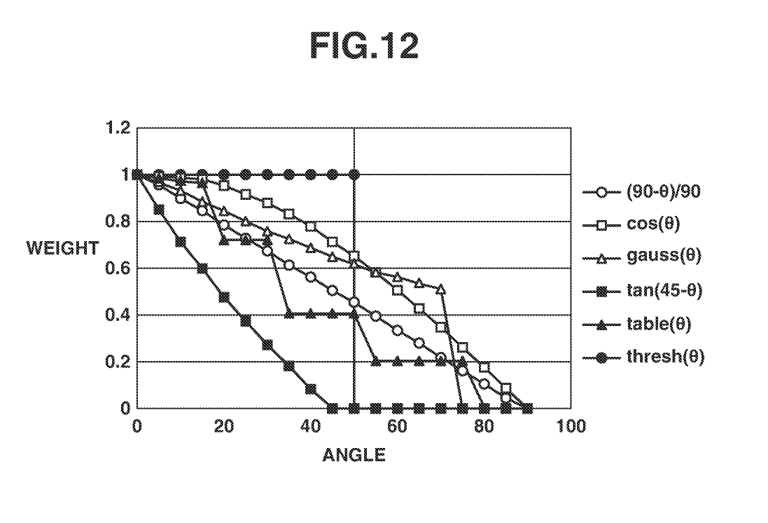

FIG. 12 is a diagram illustrating an example of a weight with respect to an angle θ. A weight cos (θ) represents a weight to be used for calculation of the evaluation value V in Expression 2. A weight thresh (θ) corresponds to a weight W in a case where a threshold of the angle θ according to the first exemplary embodiment is set to 50°. A weight (90−θ)/90 represents a weight to be linearly reduced with respect to the angle θ. A weight gauss (θ) represents a weight that decreases with respect to the angle θ according to normal distribution and becomes zero if the angle θ exceeds a threshold. A weight tan (45−θ) represents a weight that becomes zero if the angle θ becomes 45° or more. A weight table (θ) represents a weight with respect to an angle θ according to a correspondence table. For example, if the shape error has been ascertained to be large, a weight such as the weight gauss (θ) which abruptly decreases with respect to the angle θ can be employed. The weight monotonically decreases with respect to a change in the angle θ from 0° to 90°.

The viewpoint evaluation unit 802 calculates an evaluation value V for all of camera viewpoints of each triangle based on a product of the weight which monotonically decreases with respect to a change in the angle θ from 0° to 90° and a resolution S of the triangle. The viewpoint selection unit 803 selects one camera viewpoint having a maximum evaluation value V on a triangle. Since the weight monotonically decreases with respect to a change in the angle θ from 0° to 90°, the viewpoint selection unit 803 preferentially selects a camera viewpoint having a small angle θ.

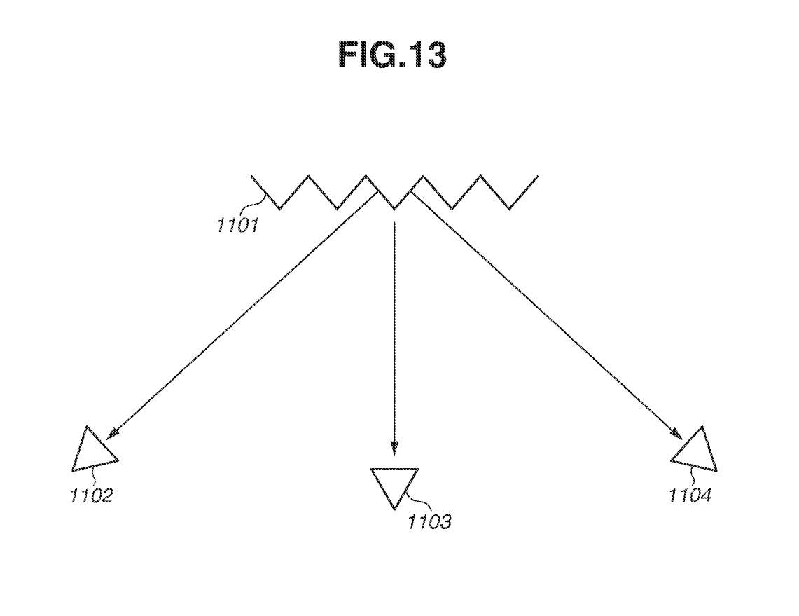

Moreover, the first exemplary embodiment has been described using an example in which a front direction of a triangle is a normal direction of the triangle to which texture is to be attached. However, in a region that is originally a plane, an uneven surface 1101 as illustrated in FIG. 13 may appear depending on an algorithm or a parameter for generation of a 3D polygon model. The appearance of the uneven surface 1101 causes a camera viewpoint 1102 or 1104 to be selected instead of a camera viewpoint 1103 that is originally provided in front. Accordingly, in the present exemplary embodiment, a front direction of a triangle is provided by normalizing the sum of normal direction vectors of triangles with four surfaces combined by a target triangle with three surfaces of triangles adjacent to the target triangle into a length 1. That is, a front direction of a triangle is an average direction of a normal direction of a target triangle and normal directions of triangles adjacent to the target triangle.

Similar to the first exemplary embodiment, in the present exemplary embodiment, a camera viewpoint providing a high resolution is preferentially selected while a camera viewpoint having a large angle θ is being excluded, and texture mapping that is robust with respect to a shape error can be executed. Moreover, according to the present exemplary embodiment, an amount of change of the evaluation value V with respect to the angle θ is reduced, so that an abrupt change in camera viewpoint selection depending on the angle θ can be prevented. Moreover, the present exemplary embodiment provides an effect in which smoothing of a front direction enhances robustness of texture mapping with respect to a shape error of a 3D polygon model.

Moreover, the method for calculating an evaluation value V can be applied to a three-dimensional point group model (3D point group model) with a normal line. The 3D point group model may be used instead of the above-described 3D polygon model. In such a case, the image processing apparatus performs a processing method hereinafter described.

The viewpoint selection unit 803 selects one camera viewpoint on a vertex from among a plurality of camera viewpoints in which images of the same subject have been captured. Such one camera viewpoint is selected in a case where pixel data is allocated to each vertex of a 3D point group model indicating a shape of the subject. The texture generation unit 804 allocates the pixel data of the image captured in the camera viewpoint selected on a vertex, to each of the vertexes. The viewpoint selection unit 803 selects one camera viewpoint based on a resolution S of a vertex from the camera viewpoint and the angle θ formed by a front direction of the vertex and a direction toward the camera viewpoint from the vertex.

The resolution S of the vertex is expressed by an area size of a vertex projected on an image captured by a camera, a focal length of the camera, or a distance between the camera and the vertex. The front direction of the vertex represents a normal direction of a vertex, as similar to FIG. 10. Moreover, the front direction of the vertex may be an average normal direction of a normal direction of a target vertex and a normal direction of a vertex adjacent to the target vertex, as similar to the description of FIG. 13.

The viewpoint selection unit 803 preferentially selects a camera viewpoint providing a high resolution S of a vertex. In the first exemplary embodiment, the viewpoint selection unit 803 selects a camera viewpoint providing a highest resolution S of a vertex from among camera viewpoints each having an angle θ that is a threshold or less. In the second exemplary embodiment, the viewpoint selection unit 803 selects one camera viewpoint according to a product of a weight that monotonically decreases with respect to a change in an angle θ from 0° to 90° and a resolution S of a vertex. The viewpoint selection unit 803 preferentially selects a camera viewpoint having a small angle θ.

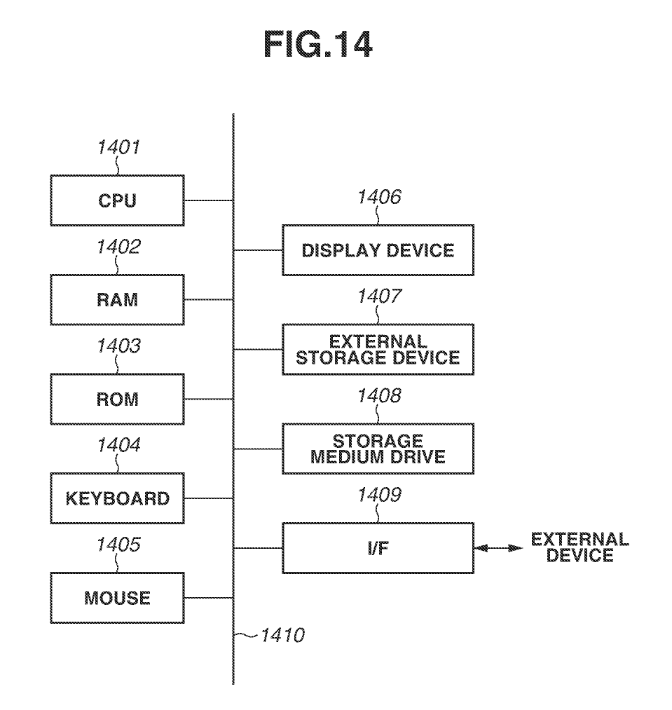

FIG. 14 is a diagram illustrating a hardware configuration example of the image processing apparatus. The image processing apparatus according to the present exemplary embodiment includes a CPU 1401 that implements functions of blocks other than a camera viewpoint image capturing unit 601 from among the blocks illustrated in the functional block diagram in FIG. 6. A correspondence relation between FIGS. 14 and 6 will be hereinafter described. An external storage device 1407 and a RAM 1402 correspond to the camera viewpoint information storage unit 609, the 3D polygon storage unit 606, and the 3D-polygon-with-texture storage unit 608 in FIG. 6. Moreover, execution of a program in the RAM 1402 by the CPU 1401 provides functions of the camera parameter acquisition unit 603, the 3D polygon acquisition unit 605, and the texture mapping unit 607 in FIG. 6. That is, the camera parameter acquisition unit 603, the 3D polygon acquisition unit 605, and the texture mapping unit 607 in FIG. 6 can be mounted as software (computer programs) to be executed by the CPU 1401. In such a case, the software is installed in a RAM 1402 of a general computer such as a personal computer (PC). Then, the CPU 1401 of the computer executes the installed software, so that the computer can provide the functions of the above-described image processing apparatus. However, one or a plurality of the functions of the blocks in FIG. 6 may be executed by a hardware processor different from the CPU 1401. Examples of such hardware processors different from the CPU 1401 include an ASIC, an FPGA, and a DSP. Each of the configurations in FIG. 14 will be hereinafter described in detail.

The CPU 1401 uses a computer program or data stored in the RAM 1402 or the ROM 1403 to not only comprehensively control the computer but also execute the aforementioned processing, which has been described as the processing to be executed by the image processing apparatus.

The RAM 1402 is one example of a computer readable storage medium. The RAM 1402 includes an area in which a computer program or data loaded from the external storage device 1407, a storage medium drive 1408, or a network interface 1409 is temporarily stored. Moreover, the RAM 1402 includes a work area to be used when the CPU 1401 executes various kinds of processing. That is, the RAM 1402 can provide various areas as necessary. The ROM 1403 is one example of a computer readable storage medium, and stores data and programs such as computer setting data and a boot program.

A keyboard 1404 and a mouse 1405 are operated by an operator of the computer. The operation of the keyboard 1404 and the mouse 1405 enables the operator to input various instructions to the CPU 1401. A display device 1406 is configured with a cathode ray tube (CRT) or a liquid crystal screen. On the display device 1406, a result of processing performed by the CPU 1401 can be displayed with images and characters.

The external storage device 1407 is one example of a computer readable storage medium, and is a large-capacity information storage device typified by a hard disk drive device. The external storage device 1407 stores, for example, an operating system (OS), a computer program or data for causing the CPU 1401 to execute the processing in FIGS. 9A and 9B, and the aforementioned various tables and database. The computer program or data stored in the external storage device 1407 is loaded to the RAM 1402 as necessary according to control to be performed by the CPU 1401, and then becomes target processing to be performed by the CPU 1401.

The storage medium drive 1408 reads out a computer program or data stored in a storage medium such as a compact disc read only memory (CD-ROM) or a digital versatile disc read only memory (DVD-ROM), and outputs the read computer program or data to the external storage device 1407 or the RAM 1402. One portion or all of pieces of the information described as having been stored in the external storage device 1407 may be recorded in the storage medium. In such a case, the information can be read by the storage medium drive 1408.

The network interface 1409 is an interface for receiving a vertex index from an external unit and outputting code data. One example of the network interface 1409 is a universal serial bus (USB). A bus 1410 connects the above-described units. In such a configuration, when the power of the computer is turned on, the CPU 1401 loads an OS to the RAM 1402 from the external storage device 1407 based on the boot program stored in the ROM 1403. As a result, an information input operation via the keyboard 1404 and the mouse 1405 can be performed, and a graphical user interface (GUI) can be displayed on the display device 1406. When a user operates the keyboard 1404 or the mouse 1405 to input an instruction to activate a texture mapping application stored in the external storage device 1407, the CPU 1401 loads the program to the RAM 1402 and executes the program. Therefore, the computer functions as the image processing apparatus.

The texture mapping application program to be executed by the CPU 1401 includes functions corresponding to the camera parameter acquisition unit 603, the 3D polygon acquisition unit 605, and the texture mapping unit 607 in FIG. 6. A result of the processing here is stored in the external storage device 1407. This computer is applicable to the image processing apparatus according to each of the first and second exemplary embodiments.

The image processing apparatus according to each of the first and second exemplary embodiments allocates images captured by cameras to a 3D polygon model to attach texture, in multiple cameras different from one another in image capturing conditions such as camera internal parameters and a distance between a camera and a subject. Even if the 3D polygon model has an error with respect to a shape of a subject, the image processing apparatus can appropriately select a camera viewpoint for allocation of texture to each polygon. Therefore, distortion of texture mapping can be reduced. If a 3D point group model is used instead of the 3D polygon model, the image processing apparatus performs similar operations and provides similar effects.

While each of the exemplary embodiments has been described, it is to be understood that the present disclosure is intended to illustrate a specific example, and not intended to limit the technical scope of the exemplary embodiments. That is, various modifications and enhancement are possible without departing from the technical concept or main characteristics of each of the exemplary embodiments.

With the system according to each of the exemplary embodiments, texture distortion due to a difference between a 3D model shape and a subject shape can be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-159144, filed Aug. 22, 2017, which is hereby incorporated by reference herein in its entirety.

What is claimed is:

1. An image processing apparatus comprising:
a selection unit configured to select a camera viewpoint corresponding to each of polygons of a 3D polygon model representing a shape of a subject from among a plurality of camera viewpoints in which images of the subject are captured; and
an allocation unit configured to determine texture to be allocated to each of the polygons of the 3D polygon model based on image data captured in the camera viewpoint selected by the selection unit,
wherein the selection unit selects a camera viewpoint corresponding to each of polygons based on (1) a resolution of the polygon from the camera viewpoint, and (2) an angle formed by a front direction of the polygon and a direction toward the camera viewpoint from the polygon.

2. The image processing apparatus according to claim 1, wherein the resolution of the polygon is represented by an area size of a polygon projected onto an image captured in the camera viewpoint.

3. The image processing apparatus according to claim 1, wherein the resolution of the polygon is represented by a size of the subject per pixel calculated from a focal length of a camera and a distance between the camera and the polygon.

4. The image processing apparatus according to claim 1, wherein the front direction of the polygon is a normal direction of the polygon.

5. The image processing apparatus according to claim 1, wherein the front direction of the polygon is an average direction of a normal direction of the polygon and normal directions of polygons adjacent to the polygon.

6. The image processing apparatus according to claim 1, wherein the selection unit uses a parameter about the resolution in preference to a parameter about the angle to select the camera viewpoint.

7. The image processing apparatus according to claim 1, wherein the selection unit selects a camera viewpoint providing a highest resolution of the polygon from among camera viewpoints each having the angle of a threshold or less.

8. The image processing apparatus according to claim 1, wherein the selection unit uses a parameter about the angle in preference to a parameter about the resolution to select the camera viewpoint.

9. The image processing apparatus according to claim 1, wherein the selection unit selects a camera viewpoint corresponding to a polygon based on a product of a weight that monotonically decreases with respect to a change in the angle from 0° to 90° and the resolution of the polygon.

10. The image processing apparatus comprising:
a selection unit configured to select a camera viewpoint corresponding to each of vertexes of a 3D point group model representing a shape of a subject from among a plurality of camera viewpoints in which images of the subject are captured; and
an allocation unit configured to determine image data to be allocated to each of the vertexes of the 3D point group model based on image data captured in the camera viewpoint selected by the selection unit,
wherein the selection unit selects a camera viewpoint corresponding to each of vertexes based on (1) a resolution of the vertex from the camera viewpoint, and (2) an angle formed by a front direction of the vertex and a direction toward the camera viewpoint from the vertex.

11. The image processing apparatus according to claim 10, wherein the resolution of the vertex is represented by a size of the subject per pixel calculated from a focal length of a camera and a distance between the camera and the polygon.

12. The image processing apparatus according to claim 10, wherein the front direction of the vertex is a normal direction of the vertex.

13. The image processing apparatus according to claim 10, wherein the front direction of the vertex is an average normal direction of a normal direction of the vertex and a normal direction of a vertex adjacent to the vertex.

14. The image processing apparatus according to claim 10, wherein the selection unit uses a parameter about the resolution in preference to a parameter about the angle to select the camera viewpoint.

15. The image processing apparatus according to claim 10, wherein the selection unit selects a camera viewpoint providing a highest resolution of the vertex from camera viewpoints each having the angle of a threshold or less.

16. An image processing method comprising:
selecting a camera viewpoint corresponding to each of polygons of a 3D polygon model representing a shape of a subject from among a plurality of camera viewpoints in which images of the subject are captured; and
allocating texture by determining the texture to be allocated to each of the polygons of the 3D polygon model based on image data captured in the camera viewpoint selected by the selecting,
wherein the selecting selects a camera viewpoint corresponding to each of polygons based on (1) a resolution of the polygon from the camera viewpoint, and (2) an angle formed by a front direction of the polygon and a direction toward the camera viewpoint from the polygon.

17. An image processing method comprising:
selecting a camera viewpoint corresponding to each of vertexes of a 3D point group model representing a shape of a subject from among a plurality of camera viewpoints in which images of the subject are captured; and
allocating image data by determining the image data to be allocated to each of the vertexes of the 3D point group model based on image data captured in the camera viewpoint selected by the selecting, wherein the selecting selects a camera viewpoint corresponding to each of vertexes based on (1) a resolution of the vertex from the camera viewpoint, and (2) an angle formed by a front direction of the vertex and a direction toward the camera viewpoint from the vertex.

18. A computer-readable storage medium storing a program for execution of an image processing method, the image processing method comprising:
selecting a camera viewpoint corresponding to each of polygons of a 3D polygon model representing a shape of a subject from among a plurality of camera viewpoints in which images of the subject are captured; and
allocating texture by determining the texture to be allocated to each of the polygons of the 3D polygon model based on image data captured in the camera viewpoint selected by the selecting,
wherein the selecting selects a camera viewpoint corresponding to each of polygons based on (1) a resolution of the polygon from the camera viewpoint, and (2) an angle formed by a front direction of the polygon and a direction toward the camera viewpoint from the polygon.

19. A computer-readable storage medium storing a program for execution of an image processing method, the image processing method comprising:
selecting a camera viewpoint corresponding to each of vertexes of a 3D point group model representing a shape of a subject from among a plurality of camera viewpoints in which images of the subject are captured; and
allocating image data by determining the image data to be allocated to each of the vertexes of the 3D point group model based on image data captured in the camera viewpoint selected by the selecting,
wherein the selecting selects a camera viewpoint corresponding to each of vertexes based on (1) a resolution of the vertex from the camera viewpoint, and (2) an angle formed by a front direction of the vertex and a direction toward the camera viewpoint from the vertex.
